(19) United States
(12) Patent Application Publication
(10) Pub. No.: US 2005/0288993 A1
(43) Pub. Date: Dec. 29, 2005

(54) Demand planning with event-based forecasting

(76) Inventors: Jie Weng, Sunnyvale, CA (US); Li Chen, Stanford, CA (US); Hau Lee, Los Altos, CA (US); Raymond Blanchard, Morgan Hill, CA (US)

Correspondence Address: FISH & RICHARDSON P.C., PO BOX 1022, MINNEAPOLIS, MN, 55440-1022, US

(21) Appl. No.: 11/168,755

(22) Filed: Jun. 27, 2005

Related U.S. Application Data
(60) Provisional application No. 60/626,194, filed on Nov. 8, 2004.
(60) Provisional application No. 60/583,832, filed on Jun. 28, 2004.

(51) Int. Cl. G06Q 90/00

(52) U.S. Cl. 705/10

(57) ABSTRACT

Methods and apparatus, including computer program products, are provided that include techniques for forecasting demand. One method includes identifying event data associated with a demand forecast. The method further includes determining a first portion of a demand forecast using the event data. The method further includes determining a second portion of the demand forecast using at least order history data. The method further includes identifying weights to be applied to the first and second portions. The method further includes determining an aggregate demand forecast including applying respective identified weights to and combining the first and second portions of the demand forecast.

### CROSS-REFERENCE TO RELATED APPLICATIONS

This application claims the benefit of U.S. Provisional Patent Application Nos. 60/626,194, filed Nov. 8, 2004, and 60/583,832 filed Jun. 28, 2004, which are incorporated by reference herein.

### BACKGROUND

Products and/or services (further referred to herein generally as “products”) are typically delivered to consumers through a network of manufacturers, distributors, transporters, retailers, and so on. Such a network of facilities that together deliver products to consumers is commonly referred to as a “supply chain” network.

Suppliers of products and services (e.g., manufactures, vendors, retailers, and so on) often face the task of forecasting the demand for the products in order to provide smooth and efficient flow of the products through the supply chain network in the presence of constantly-changing market conditions. Overestimating the demand can result in overproduction and increased costs associated with holding inventories (e.g., storage costs, obsolescence, and so on). Underestimating the demand, on the other hand, can result in lost revenues. Accordingly, the accuracy of a supplier's demand forecasts can directly affect the supplier's profits.

One technique for forecasting demand for a product (further referred to as “conventional method”) is to forecast the demand based primarily on historical demand information for that product (e.g., based on past purchase orders, past shipments, past point-of-sales data, and so on). However, such a technique may poorly adapt to the ever-changing market conditions and can result in an inaccurate forecast.

### SUMMARY OF THE INVENTION

Methods and apparatus, including computer program products, are provided that include techniques for forecasting demand. In one aspect, a method is provided that includes identifying event data associated with a demand forecast. The method further includes determining a first portion of a demand forecast using the event data. The method further includes determining a second portion of the demand forecast using at least order history data. The method further includes identifying weights to be applied to the first and second portions. The method further includes determining an aggregate demand forecast including applying respective identified weights to and combining the first and second portions of the demand forecast.

Aspects can include one or more of the following features. The event data can be real-time event data. The event data can also be downstream event data. The event data can further be RFID data, including EPC data.

The method can be performed at a manufacturer distribution center for orders received from one or more retail distribution centers.

The first portion can be determined using event data corresponding to shipments made from a retail distribution center. Determining the first portion can include determining a relationship between the event data and prior orders. Determining a relationship can include determining a one-to-one relationship. Determining a relationship can also include determining a one-to-one relationship between shipment information from a retail distribution center to subsequent orders received therefrom. Determining the second portion can include using historical order data from a respective downstream element in the supply chain to calculate a partial demand.

Determining weights can include determining predetermined weights. Determining weights can also include determining estimated weights. Determining estimated weights can include determining estimates based on historical data associated with an associated product. Determining the weights can also include estimating the weights. Estimating can include determining a correlation associated with the aggregate forecast using other data. Other data can be historical data related to a demand forecast for a product. Other data can also be data related to another product. Other data can be related to another downstream element.

The aggregate demand forecast can be associated with a product. The aggregate demand forecast can also be associated with a service. The aggregate demand forecast can also be associated with a product and the history data can be associated with previous orders for the product received from a downstream element in a supply chain for the product.

In another aspect, a method is provided that includes identifying event data downstream from a location in a supply chain where a demand forecast is to be determined. The method further includes identifying a relationship of the event data with the demand forecast. The method further includes using the relationship to determine estimates for weights to be used in determining an associated aggregate demand forecast. The method further includes determining a first portion of a demand forecast using the event data. The method further includes determining a second portion of the demand forecast using at least order history data. The method further includes applying the estimated weights to the respective first and second portions. The method further includes determining an aggregate demand forecast including combining the first and second portions of the demand forecast.

In another aspect, a method is provided that includes identifying event data associated with a first product downstream from a location in a supply chain where a demand forecast is to be determined. The method further includes determining a correlation between event data and order forecast in the supply chain. The method further includes using the correlation to determine estimates for weights to be used in determining an associated aggregate demand forecast for the second product. The method further includes determining a first portion of a demand forecast using the event data.

The invention can be implemented to realize one or more of the following advantages. Real-time events and event data collection can be used to generate more accurate demand forecasts.

Details of one or more implementations of the invention are set forth in the accompanying drawings and in the description below. Further features, aspects, and advantages of the invention will become apparent from the description, the drawings, and the claims.

### BRIEF DESCRIPTION OF THE DRAWINGS

FIG. 1 is a block diagram of an example supply chain network.

FIG. 2 is a block diagram of a demand planning system for a manufacturer distribution center according to one implementation.

FIG. 3 is a block diagram of a forecast engine according to one implementation.

FIG. 4 is a flowchart illustrating a process for forecasting demand when there is a known relationship between demand and downstream event data.

FIG. 5 is a flowchart illustrating a process for forecasting demand where there is a known relationship between demand and downstream event data with unknown weights.

FIG. 6 is a flowchart illustrating a process for forecasting demand where there is no known relationship between demand and down stream event data.

Like reference numbers and designations in the various drawings indicate like elements.

### DETAILED DESCRIPTION

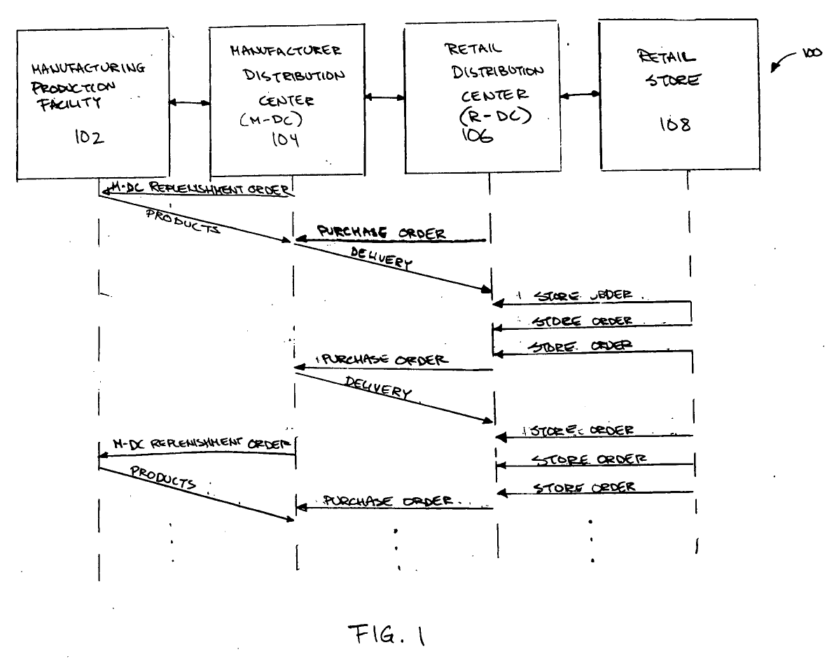

Referring to FIG. 1, a supply chain network 100, in one implementation, can include one or more manufacturing production facilities 102, one or more manufacturer distribution centers (M-DC) 104, one or more retail distribution centers (R-DC) 106, and one or more retail stores 108. For the purpose of simplicity, one manufacturing production facility 102, one M-DC 104, one R-DC 106, and one retail store 108 are shown in FIG. 1. However, it should be understood that the present invention can be applied to any other supply chain setting, including those that include plural M-DCs, plural R-DCs, an/or plural retail stores.

Products can be manufactured at a manufacturing production facility 102 (e.g., a plant). Manufacturing products, for example, can include procuring raw materials and turning the raw materials into finished and/or intermediate products.

The manufactured products can then be transferred to a M-DC 104, which can distribute the products. The products can be transferred to a respective M-DC in accordance with replenishment orders that are received from the M-DC.

In one implementation, distributing products includes delivering the products to one or more retail distribution centers (R-DC) 106, e.g., in accordance with purchase orders that are received from the retail distribution centers 106. In one implementation, one general inventory rule requires that a large enough inventory must be maintained at a respective M-DC 104 to be able to respond quickly to purchase orders from any of the M-DC's respective R-DCs. At the same time, it may be preferable to control the size of the inventory at the M-DC 104 to avoid overstocking.

In one implementation, the R-DC's 106 can ship the products received from the manufacturer distribution centers 104 to one or more retail stores 108 (e.g., based on store orders received from the respective retail stores 108). Again, an optimal inventory at an R-DC 106 can, in one implementation, be maintained large enough to accommodate the retail stores 108 but also small enough to be liquid.

The retail stores 108 can in turn sell the products to consumers. As the products travel from manufacturing production facilities 102 to consumers, the products can take on different shapes and forms. That is, the products can be packaged, assembled into sets, transformed into other products, and so on.

Products flowing through the supply chain network 100 can be tracked using, for example, EPC and the RFID technologies. For example, each product can include a tag with an electronic product code (EPC) uniquely identifying the product. An EPC can be electronically read and transmitted over a network using Radio Frequency Identification (RFID) technology. Electronically reading an EPC tag of a product can include determining the unique ID of the product, determining the location of the product, recording the time when the EPC tag is read, and so on. Other tracking means can be used including bar codes and bar code records. Additionally, other tracking methodologies can be used including tracking at the product level, pallet level or otherwise. Further, tracking, as it used herein refers to the receipt and processing at a node in the supply chain network 100 (e.g., an M-DC 104) of event data that relates to the processing of the product or products at downstream facilities, up to and including the retail store level. The event data can take many forms, and plural event data can be used in the generation of replenishment requests. The generation of replenishment requests is discussed in greater detail below.

By way of example, demand forecasting can be required to be implemented at one or more locations along the supply chain network 100. For example, an M-DC can use demand forecasting to determine the amount of product that needs to be ordered from an associated manufacturing production facility 102 to support incoming orders for the product from one or more R-DCs 106 in the supply chain network 100. Other locations in the supply chain network 100 can use demand forecasting methodologies similar to those described herein, or other conventional means. For the purpose of clarity, a demand forecasting methodology according to aspects of the invention is described below with reference to structures in an M-DC 104. Those of ordinary skill in the art will recognize that similar methods can be used at other locations in the supply chain network 100.

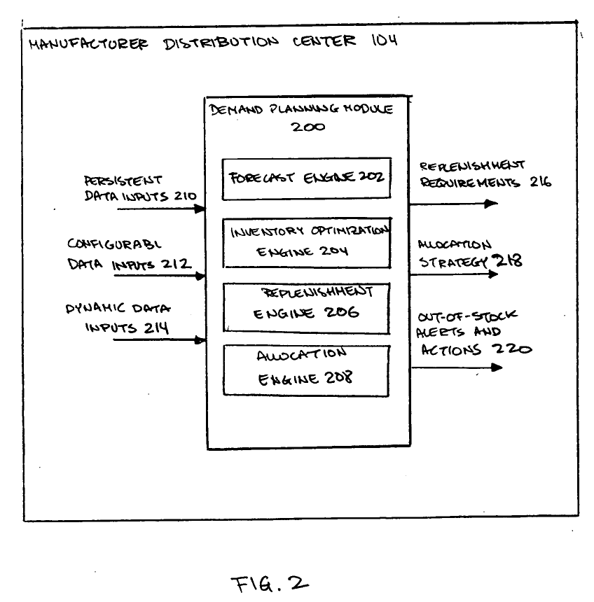

Referring to FIG. 2, an M-DC 104, in one implementation, can include a demand planning module 200 to forecast forthcoming purchase orders and/or shipments, thus, maintain an inventory of products in line with the forecasts. The demand planning module 200 can include multiple inputs and multiple outputs and multiple engines.

Inputs of the demand planning module 200 can include persistent data inputs 210. The persistent data inputs 210 can include products master data, which can define the stock keeping unit (SKU) attributes of each product. For example, master data for a given product can include the global trade item number (GTIN) of the product, the packaging information for the product, category information for the product, special shipment requirements for the product (e.g., whether the product has to be transported on refrigerated trucks), dimensions of the product, manufacturers of the product, and so on.

The persistent data inputs 210 can further include location master data, which can identify different locations and sub-locations in the supply chain network 100. For example, location master data (for a given location) can include a global location number (GLN), type of the location, address of the location, capacity of the location, relationship of the location to other locations, and so on.

Inputs of the demand planning module 200 can further include configurable data inputs 212. For a given product (or for a given retailer), configurable data inputs 212 can include the minimum required service level, frequency of purchase orders, order processing delays, and lead times and variability between different locations in the supply chain network 100. Configurable data inputs 212 for a given product can further include rounding policies for shipping, estimates of pilferage (e.g., thefts, damages, disposals due to expiration of dated products, and so on), and historical bullwhip factors. Other configurable data inputs 212 can include various constraints, such as no delivery on Saturday and Sunday.

Inputs of the demand planning module 200 can further include dynamic data inputs 214. Dynamic data inputs 214 can include purchase orders, point-of-sales data, and real-time events, e.g., electronic product code (EPC) events and other downstream event data. The downstream event data can be received from various locations in the supply chain network 100 (e.g., retail stores 108, R-DC 106, and so on). Examples of events include outbound shipments from an R-DC to one or more retail stores 108, receipt of shipments at an R-DC, outbound shipment of product from an R-DC to retail stores 108, receipt at retail stores 108, store-level movement of inventory (e.g., from back room of the store to the shopping floor), and so on. In some implementations, dynamic data inputs 214 can include upstream event data (e.g., manufacturing production facility 102 shipment data) to facilitate improved demand forecasting (e.g., to take into account an unexpected shipment or fulfillment or short fill of a current order).

Outputs of the demand planning module 200 can include replenishment requirements 216 to be directed to an upstream manufacturing enterprise and required to fulfill the demand from all retail distribution centers 106 associated with a given M-DC. For example, the replenishment requirements 216 can be sent to (e.g., as part as a replenishment order) a manufacturing production facility 102 in order to restock the inventory at the M-DC 104.

Outputs of the demand planning module 200 can further include an allocation strategy 218, which can be a set of rules for distributing the in-stock products in case the demand from all R-DCs 106 is not met by the M-DC on-hand inventory.

Outputs of the demand planning module 200 can further include various kinds of out-of-stock alerts and actions 220. For example, out-of-stock alerts and actions 220 can be generated when inventory falls below predicted demand forecasts. An out-of-stock alert 220 can be used to trigger certain exception management procedures, such as expediting, transfer shipments, and so on.

In one implementation, the demand planning module 200 can include a plurality of engines including one or more forecast engines 202, one or more inventory optimization engines 204, one or more replenishment engines 206, and one or more allocation engines 208.

A forecast engine 202 can predict order quantities of the forthcoming purchase orders from retail distribution centers 106, as will be described in greater detail below. In one implementation, the demand planning module 200 can include one forecast engine 202 for each product or SKU. In other implementations, the demand planning module 200 can include one forecast engine 202 per product, per R-DC 106, or one forecast engine 202 per product, per R-DC 106, per retail store 108, or other configurations.

An inventory optimization engine 204 can determine a desired inventory for an M-DC 104, e.g., based on the predictions provided by the forecast engines 202. In one implementation, the demand planning module 200 can include one inventory optimization engine 204 for each product. In other implementations, the demand planning module 200 can include one inventory optimization engine 204 per product, per R-DC 106, or one inventory optimization engine 204 per product, per R-DC 106, per retail store 108, and or other configurations.

In one implementation, the desired inventory can be calculated as a sum of the cycle stock and the safety stock. The cycle stock can be determined as the sum of all predicted orders within an order cycle. The safety stock can be a demand buffer, calculated as a function of the forecast variability and lead time variability of the order cycle. The calculation of cycle stock is based on the purchase order forecast. Determining the purchase order forecast is discussed in greater detail below.

A replenishment engine 206 can determine the actual replenishment quantities, e.g., based on the results provided by an associated inventory optimization engine 204. The demand planning module 200 can include one replenishment engine 206 for each product. In other implementations, the demand planning module 200 can include one replenishment engine 206 per product, per R-DC 106, or one replenishment engine 206 per product, per R-DC 106, per retail store 108, or other configurations.

In one implementation, the replenishment quantity can be calculated as the difference between the optimal inventory (e.g., provided by the inventory optimization engine 204) and the inventory on hand and in transit. This amount can be adjusted based on shipping constraints (e.g., transportation schedules, minimum order quantities required by the suppliers, and so on).

An allocation engine 208 can provide an allocation strategy in case the demand from all R-DCs 106 is not met by the M-DC on-hand inventory, as described earlier. In one implementation, the allocation engine 208 can equally allocate in-stock products to various retail distribution centers 106. Alternatively, a prioritization system can be used to allocate in-stock products unequally to different retail distribution centers 106 based on the different requirements of the different retail distribution centers 106, or other considerations.

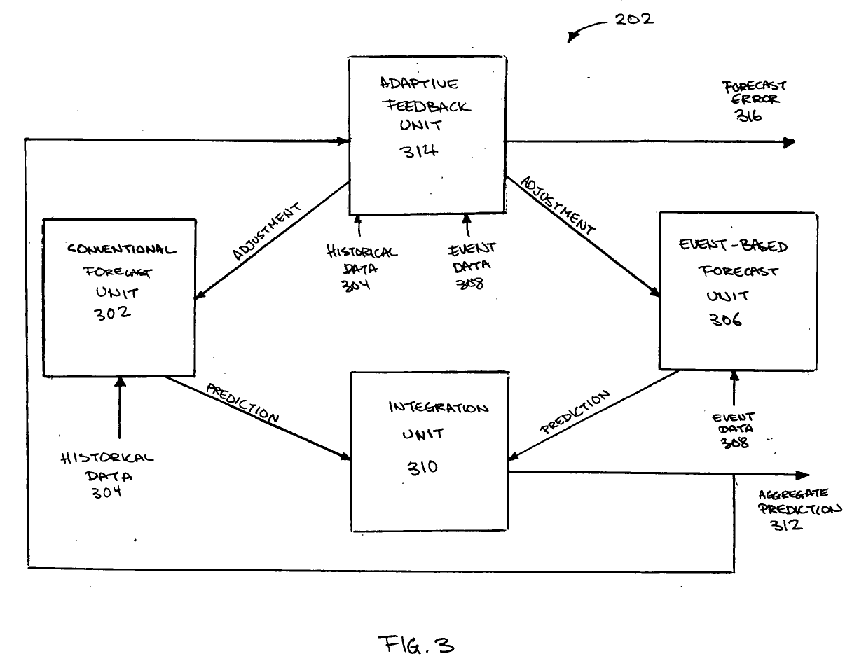

Referring to FIG. 3, a forecast engine 202, in one implementation, can include a conventional forecast unit 302 that uses a conventional method of forecasting demand to predict order quantities for forthcoming purchase orders including the use of historical data as discussed above. For example, the conventional forecast unit 302 can make predictions based on historical data 304 (e.g., past purchase orders) and various forecast parameters, as will be described in greater detail below.

The forecast engine 202 can further include an event-based forecast unit 306, which uses event data (e.g., real-time event data) 308 to predict order quantities for forthcoming purchase orders. For example, the event-based forecast unit 306 can make a prediction based on EPC events (e.g., outbound shipments from an R-DC 106 to retail stores 108) and various forecast parameters, as will be described in greater detail below.

The forecast engine 202 can further include an integration unit 310 which can provide an aggregate prediction 312 of order quantities for forthcoming purchase orders based on the predictions provided by the conventional forecast unit 302 and the event-based forecast unit 306. In one implementation, the aggregate prediction 312 provided by the integration unit 310 can be a weighted sum of the prediction provided by the conventional forecast unit 302 and the prediction provided by the event-based forecast unit 306.

In one implementation, the integration unit 310 can assign weights to the predictions provided by the conventional forecast unit 302 and the event-based forecast unit 306. The integration unit 310 can then provide the aggregate prediction 312 by combining predictions provided by the conventional forecast unit 302 and the event-based forecast unit 306 in accordance with the assigned weights. Alternatively, the conventional forecast unit 302 and the even-based forecast unit 306 can determine their own weights, and the integration unit merely only need to combine the respective forecasts.

The forecast engine 202 can further include an adaptive feedback unit 314. When a purchase order is received from an R-DC 106, the adaptive feedback unit 314 can compare the received order quantities of the purchase order with the predicted order quantities (e.g., aggregate prediction 312 determined by the integration unit 310) for that order and provide a value of forecast error 316. The adaptive feedback unit 314 can further tune the conventional forecast unit 302 and the event-based forecast unit 306 outputs, e.g., by adjusting forecast parameters of each unit, based on the forecast error 316. Optionally, the adaptive feedback unit 314 can use historical data 304 and event data 308 to tune the conventional forecast unit 302 and the event-based forecast unit 306.

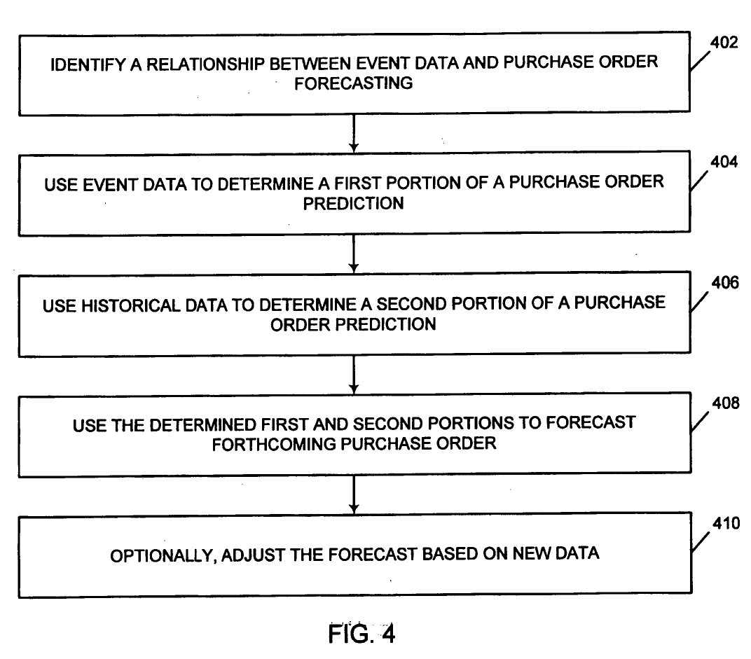

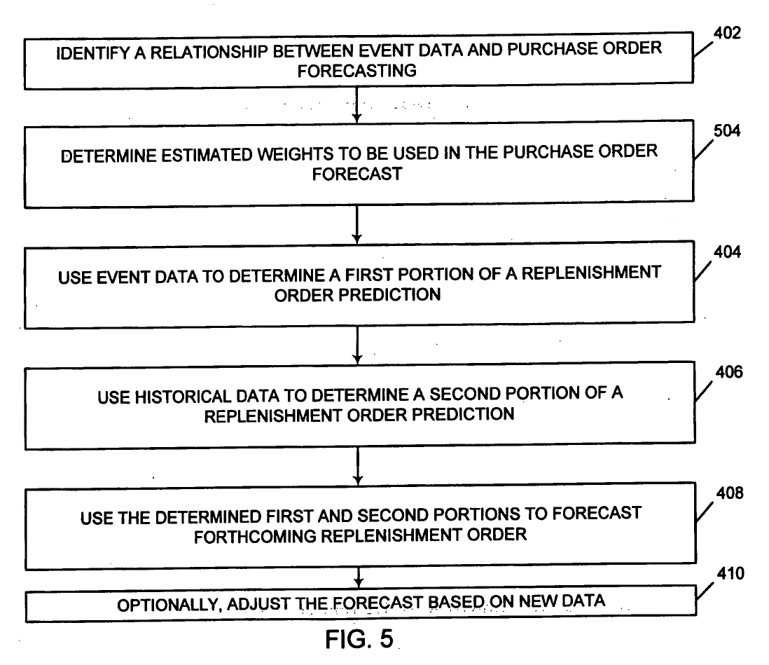

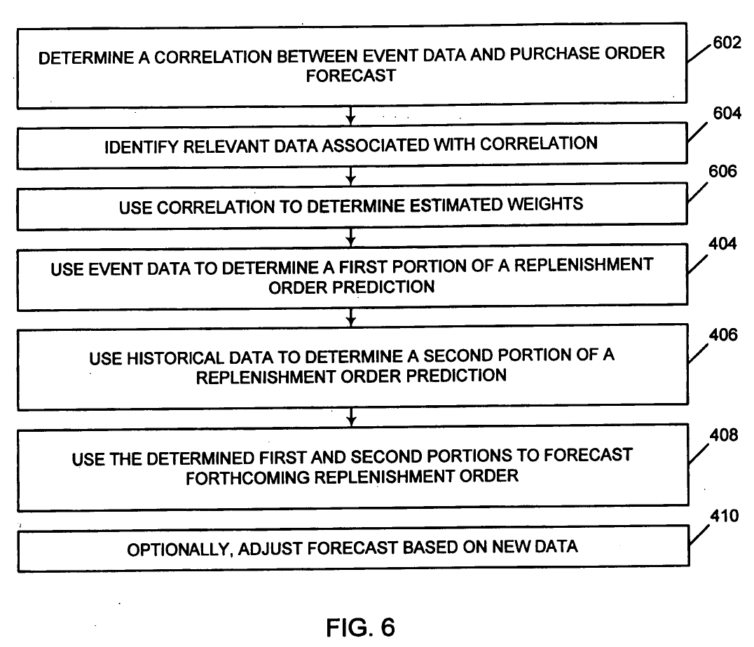

Referring to FIG. 4, FIG. 5, and FIG. 6, several example scenarios will be used to demonstrate the functionality of one implementation of the forecast engine 202, operating in a supply chain network 100 shown in FIG. 1, in forecasting demand for a single SKU. In these examples, the R-DC order cycle will be denoted as L units (e.g., L days for simplicity). The purchase orders received by the M-DC 104 from the R-DC 106 will be denoted as Dₜ, D_{t+L}, D_{t+2L}, and so on. The outbound shipments from the R-DC 106 to the retail stores 108 (assumed to be daily for simplicity) will be denoted as dₜ, dₜ₊₁, dₜ₊₂, and so on. It will be assumed that the demand forecast is performed at time t+m. Those of ordinary skill in the art will recognize that the techniques described in association with this example can be used by other elements in the supply chain network 100 (e.g., other elements that need to predict the order behavior of a downstream element), can use other event data (e.g., retail point of sale information, receipt information for shipments received at a retailer, or other downstream event data), or be applicable to other configurations (e.g., demand for more than one SKU).

In a first example scenario, a known relation is identified between purchase orders received and downstream event data. Based on this relationship, a first portion of the prediction of a future purchase order for a given downstream element will be made using collected event data. A second portion of the demand forecast is determined using conventional demand planning forecasting methodologies. For example, in the scenario shown in FIG. 4, a relation is defined between purchase orders received and real time data collected related to outbound shipments from a given R-DC.

Referring to FIG. 4, in one scenario, a relationship is identified between the downstream event data and a purchase order forecast (step 402). For example, there may be a known relation between purchase orders received by the M-DC 104 from the R-DC 106 and the outbound shipments from the R-DC 106 to the retail stores 108 (further referred to as “order-shipment relation”). For example, a retailer's order can be primarily dictated by that retailer's consumption rate.

An order-shipment relation can be typically described as D_{t+L}=w₁·dₜ+w₂·dₜ₊₁+ . . . +w_{L}·d_{t+L-1}, where w₁, . . . ,w_{L} are known weights on the daily shipments. In a simple example, w₁= . . . =w_{L}=1. That is, the R-DC 106 orders the exact amount of inventory that has been withdrawn from it in the last L days.

Within a given order cycle, relevant event data can be collected and provided to a prediction device to determine a first portion of a purchase order prediction (step 404). In this example the relevant data can be of the form of data associated with outbound shipments from the R-DC 106 to the retail stores 108 up until the time demand forecasting is performed (i.e., dₜ, dₜ₊₁ . . . dₜ₊ₘ₋₁). The data can be obtained using real-time events, e.g., real-time EPC events at the point of shipment. A second portion of the purchase order prediction associated with the downstream element (e.g., to support the R-DC's outbound shipments from the R-DC 106 to the retail stores 108 in that order cycle, i.e., future shipments) is denoted as wₜ₊ₘd′ₜ₊ₘ+ . . . +w_{t+L-1}d′_{t+L-1}, and is predicted by disaggregating the conventional forecast of the next purchase order, or by using historical information, e.g., of the R-DC 106 daily shipments to the retail stores 108 (step 406).

The obtained outbound shipments dₜ, dₜ₊₁ . . . dₜ₊ₘ₋₁ and the predicted future shipments d′ₜ₊ₘ . . . d′_{t+L-1} (or in the aggregate form of wₜ₊ₘd′ₜ₊ₘ+ . . . +w_{t+L-1}d′_{t+L-1}) can be used to forecast the forthcoming purchase order D_{t+L}. That is, the obtained outbound shipments dₜ, dₜ₊₁ . . . dₜ₊ₘ₋₁ and the predicted future shipments d′ₜ₊ₘ . . . d′_{t+L-1} can be substituted into the order-shipment relation (step 408) to forecast the forthcoming purchase order D_{t+L} as, for example expressed below (where D′_{t+L} denotes the forecast of D_{t+L}):
D′_{t+L}=w₁d₁+ . . . +wₘdₜ₊ₘ₋₁+wₘ₊₁d′ₜ₊ₘ . . . +w_{L}d′_{t+L-1}.

The substitution can include applying appropriate weightings (e.g., using the known weights w₁ . . . w_{L}) as required. For example, in a simple seven day order cycle that includes three days of shipment data where each day in the cycle is equally weighted (e.g., w₁= . . . =w_{L}=1), the aggregate purchase order prediction (the sum of the first and second portions of the purchase order prediction) can be determined based on a sum of the event data received (the real time data that indicates the downstream shipments in this example) and an appropriate weighting of a conventional prediction of the next purchase order (e.g., 4/7 weighting in this simple example).

Other weightings can be used. For example, historical data relating to the order cycle, other shipments, other orders, other data associated with other upstream or downstream elements can be used to adjust the relevance of each portion of the aggregate prediction. Further, other weights can be used to adjust for example, for known relationships with unknown weights, or for unknown relationships with unknown weights as will be discussed in greater detail below in relationship to FIGS. 5 and 6.

In one implementation, the process for forecasting a forthcoming purchase order described in reference to FIG. 4 can be performed once. Alternatively, multiple iterations of the process can be performed as new data (e.g., event-data) arrives, and the forecast for the forthcoming purchase order can be adjusted based on the new data (step 410).

As discussed above, a combination of conventional and event-based forecasting can be used when known relationships with known weights exist between the collected event data and future purchase orders. In some implementations, these relationships and/or weights may not be known.

Referring to FIG. 5, in another scenario, there may be a known relationship with unknown weights between collected event data associated with a product and future purchase orders (e.g., between purchase orders received by the M-DC 104 from the R-DC 106 and the outbound shipments from the R-DC 106 to the retail stores 108 in the example given above). That is, weights w₁, . . . ,w_{L} in the scenario described in reference to FIG. 4 may not be known (i.e., predetermined). However, other data (e.g., other event data or historical data) may be able to be used to assist in producing an improved prediction that reflects known data as of the time of a demand forecast. In one implementation, estimates can be used to facilitate the forecasting process. In one particular example, steps similar to those described above (collection of data, and determination of the first and second portions of the forecast as described above) are performed and estimated weights can be used to create an aggregate order prediction.

Referring now to FIG. 5, as discussed in reference to FIG. 4, a relationship is identified between the downstream event data and purchase order forecast (step 402). Thereafter, estimated weights to be used in the purchase order forecast (e.g., weights w₁, . . . ,w_{L} in the order-shipment relation) can be determined (step 504). In one implementation, historical information of R-DC 106 daily shipments and R-DC 106 purchase orders can be used to identify and estimate the weights w₁, . . . ,w_{L} (e.g., by using conventional statistical methods, such as linear regression, known to one of ordinary skill in the art). Since the estimated weights w₁, . . . ,w_{L}, are not predetermined, the weights w₁, . . . ,w_{L} can be updated dynamically as new data of R-DC 106 purchase orders and outbound shipments are collected. Once the weights w₁, . . . ,w_{L} are estimated, the method described with reference to FIG. 4 (steps 404-410) can be performed to forecast the forthcoming purchase order D_{t+L} using the estimated weights.

Referring to FIG. 6, in another scenario, there may be an unknown relationship between collected event data associated with a product and future purchase orders (e.g., between purchase orders received by the M-DC 104 from the R-DC 106 and the outbound shipments from the R-DC 106 to the retail stores 108 in the example given above). In this scenario, a correlation between one or more types of collected data (e.g., other event data or historical data associated with other products or other portions of the supply chain network 100) and the future purchase orders can be determined. The determined correlation can be used to estimate appropriate weights and produce an improved prediction that reflects known data as of the time of a demand forecast. In one implementation, a correlation is determined between for example a given product and other products, and estimates are for the weightings are derived from the correlation. In one particular example, steps similar to those described above (collection of data, and determination of the first and second portions of the forecast as described above) are performed and estimated weights can be used to create an aggregate order prediction.

Referring to FIG. 6, a correlation is determined between event data and a purchase order forecast (602). In the example above, there may be no clear relationship between purchase orders received by the M-DC 104 from the R-DC 106 and the outbound shipments from the R-DC 106 to retail stores 108. However, there may exist a correlation between purchase orders of an R-DC and one or more other quantities in, or parameters of, the supply chain network 100 (further referred to as “supply network quantities”). These supply network quantities can be obtained, for instance, through EPC events. Such correlation, or correlations, can be calculated based on historical data using conventional regression techniques. For example, a correlation can be made to a similar product at a same R-DC, a similar product at a different R-DC, a different product at a same R-DC, etc. Other correlation examples are possible. In one implementation, if no correlation can be made, conventional statistical forecasting methods can be used to forecast the forthcoming purchase order. Conventional forecasting methods can include exponential smoothing, and other time-series and causal forecasting methods.

Relevant data associated with the determined correlation is identified (step 604). Relevant data can be, for example, the event data for another product, another location, and so on. The correlation is then used to determine estimated weights (606). Note, if no correlation can be made, then the weights used for the event data are set to zero and the weight applied to the conventional forecast is set to one. Hence, effectively the purchase order forecast is generated by the conventional forecasting method. Once the weights w₁, . . . ,w_{L} are estimated, the method described with reference to FIG. 4 (steps 404-410) can be performed to forecast the forthcoming purchase order D_{t+L} using the estimated weights. In one implementation, as new data is gathered about different supply chain network quantities (e.g., through EPC events), the forecasted order can be adjusted based on a recalculated correlation (step 410). When the correlation is close to zero, the adjustment step (step 410) can essentially be omitted. The relative accuracy of the correlation can be determined using feedback error (based on actual purchase orders received). The addition of an adjustment step (step 410) can result in improved forecast accuracy in the presence of relatively high correlation between the R-DC 106 purchase orders and other supply chain network quantities.

In a given supply chain network 100, there may exist various correlations between different supply chain network quantities. For example, there may exist a correlation between purchase orders of an R-DC 106 and outbound shipments of that R-DC 106. Similarly, there may exist a correlation between purchase orders of an R-DC 106 and purchase orders and/or outbound shipments of another R-DC 106. Likewise, there may exist a correlation between purchase orders for different products (e.g., a complementary good and substitute goods). Therefore, the method outlined in reference to FIG. 6 is not limited to any particular kind of a correlation. Instead, any correlation in the supply chain network 100 can be used to improve accuracy in forecasting forthcoming purchase orders.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

The invention can be implemented in a computing system that includes a back-end component (e.g., a data server), a middleware component (e.g., an application server), or a front-end component (e.g., a client computer having a graphical user interface or a Web browser through which a user can interact with an implementation of the invention), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments, but other embodiments can be implemented and are within the scope of the following claims. For example, the operations of the invention can be performed in a different order and still achieve desirable results. As one example, the process depicted in FIG. 6 does not require the particular order shown, or sequential order, to achieve desirable results (e.g., the operations 602 and 604 can be performed in the reverse order).

Furthermore, the described demand forecasting technique can be performed at an R-DC 106 (or at other locations in the supply chain network 100). Historical data about store orders can be used to generate the conventional forecasts, and case movements and point-of-sale data can become contributors to the correlation. Moreover, an M-DC 106 can be “co-located” (i.e, at the same physical location) with the manufacturing production facility 102. In such a case, the requirements generated for the demand forecast become production orders.

Outbound shipments from retail distribution centers 106 to retail stores 108 have been used as examples of event data for illustrative purposes. However, other event data can also be used either in adjusting or estimating portions of the order forecast or elements thereof including store-level inventory movement, point-of-sale data, and so on.

The supply chain network 100 including a manufacturing production facility 102, and M-DC 104, and R-DC 106, and a retail store 108 is one example implementation. The techniques disclosed herein are applicable to demand forecasting in other supply chain networks and in other systems.

1. A method for demand forecasting in a supply chain comprising:
identifying event data associated with a demand forecast;
determining a first portion of a demand forecast using the event data;
determining a second portion of the demand forecast using at least order history data;
identifying weights to be applied to the first and second portions; and
determining an aggregate demand forecast including applying respective identified weights to and combining the first and second portions of the demand forecast.

2. The method of claim 1, wherein the event data is real-time event data.

3. The method of claim 1, wherein the event data is downstream event data.

4. The method of claim 1, wherein the event data is RFD) data.

5. The method of claim 4, wherein the RFID data includes EPC data.

6. The method of claim 1, wherein the method is performed at a manufacturer distribution center for orders received from one or more retail distribution centers.

7. The method of claim 1, wherein the first portion is determined using event data corresponding to shipments made from a retail distribution center.

8. The method of claim 1, wherein determining the first portion includes determining a relationship between the event data and prior orders.

9. The method of claim 8, wherein determining a relationship includes determining a one-to-one relationship.

10. The method of claim 8, wherein determining a relationship includes determining a one-to-one relationship between shipment information from a retail distribution center to subsequent orders received therefrom.

11. The method of claim 1, wherein determining the second portion includes using historical order data from a respective downstream element in the supply chain to calculate a partial demand.

12. The method of claim 1, wherein determining weights includes determining predetermined weights.

13. The method of claim 1, wherein determining weights includes determining estimated weights.

14. The method of claim 13, wherein determining estimated weights includes determining estimates based on historical data associated with an associated product.

15. The method of claim 1, wherein determining the weights includes estimating the weights, the estimating including determining a correlation associated with the aggregate forecast using other data.

16. The method of claim 15, wherein the other data is historical data related to a demand forecast for a product.

17. The method of claim 15, wherein the other data is data related to another product.

18. The method of claim 15, wherein the other data is related to another downstream element.

19. The method of claim 1, wherein the aggregate demand forecast is associated with a product.

20. The method of claim 1, wherein the aggregate demand forecast is associated with a service.

21. The method of claim 1, wherein the aggregate demand forecast is associated with a product and the history data is associated with previous orders for the product received from a downstream element in a supply chain for the product.

22. A method for demand forecasting in a supply chain comprising:
identifying event data downstream from a location in a supply chain where a demand forecast is to be determined;
identifying a relationship of the event data with the demand forecast;
using the relationship to determine estimates for weights to be used in determining an associated aggregate demand forecast;
determining a first portion of a demand forecast using the event data;
determining a second portion of the demand forecast using at least order history data;
applying the estimated weights to the respective first and second portions; and
determining an aggregate demand forecast including combining the first and second portions of the demand forecast.

23. A method for demand forecasting in a supply chain comprising:
identifying event data associated with a first product downstream from a location in a supply chain where a demand forecast is to be determined;
determining a correlation between event data and order forecast in the supply chain;
using the correlation to determine estimates for weights to be used in determining an associated aggregate demand forecast for the second product;
determining a first portion of a demand forecast using the event data;
determining a second portion of the demand forecast using at least order history data;
applying the estimated weights to the respective first and second portions; and
determining an aggregate demand forecast for the second product including combining the first and second portions of the demand forecast.
